(19) United States
(12) Patent Application Publication
(10) Pub. No.: US 2022/0216506 A1
(43) Pub. Date: Jul. 7, 2022

(54) WET-CHEMICALLY PREPARED POLYMERIC LITHIUM PHOSPHORUS OXYNI-TRIDE (LIPON), METHOD FOR THE PREPARATION THEREOF, USES THEREOF, AND BATTERY

(71) Applicant: Fraunhofer-Gesellschaft zur Förderung der angewandten Forschung e.V., München (DE)

(72) Inventors: Gideon Abels, Bremen (DE); Ingo Bardenhagen, Bremen (DE); Julian Schwenzel, Bremen (DE); Matthias Busse, Bremen (DE)

(21) Appl. No.: 17/595,420

(22) PCT Filed: May 12, 2020
(86) PCT No.: PCT/EP2020/063188

§ 371 Date: Nov. 16, 2021

(30) Foreign Application Priority Data
May 16, 2019 (DE) 10 2019 207 196.1

(51) Int. Cl. H01M 10/0562; C01B 21/097; H01M 10/058; H01M 10/0525

(52) U.S. Cl. CPC H01M 10/0562; C01B 21/0975; H01M 10/058; H01M 2300/0068; C01P 2006/40; C01P 2002/86; C01P 2002/82; H01M 10/0525

(57) ABSTRACT

A polymeric lithium phosphorus oxynitride (LiPON) battery can be prepared by reacting a polymetaphosphonic acid with an organolithium compound to provide a reaction product of LiPON and including the reaction product in the LiPON battery. The LiPON is soluble in solvents selected from the group consisting of dimethyl sulfoxide (DMSO), tetrahydrofuran (THF), toluene and N-methylpyrrolidone (NMP).

The present invention relates to a wet-chemically prepared polymeric lithium phosphorus oxynitride (LiPON), a method for the preparation thereof, uses thereof, and a battery which contains a solid-state electrolyte produced from the LIPON according to the invention. The present invention also relates to a method for producing a corresponding battery.

Lithium-ion batteries nowadays consist of a graphite anode, a transition-metal cathode, and a liquid electrolyte. The next generation of lithium-ion batteries should be able to store considerably more energy than previously, and this requires new electrode materials to be used. These include metal lithium, which provides a very high capacity as an anode material and can generate high cell voltages. Metal lithium reacts with almost all known electrolytes, however, and, with the electrolytes that are currently commercially used, this results in gas and heat being released and therefore in the battery being destroyed. In addition, these electrodes exhibit pronounced volume changes during the charging and discharging cycles, which results in the formation of dendrites, inter alia. These are “branches” made of metal lithium which connect the anode to the cathode and can thus cause a short circuit in the battery or thermal runaway, which destroys the battery.

Commercial lithium-ion batteries use graphite as the anode material instead of metal lithium. This is what is known as an intercalation electrode, in which lithium ions can be received without being reduced to metal lithium. As a result, reactions between lithium and the liquid electrolyte are largely prevented. Although a small fraction of the electrolyte decomposes on the anode, the resulting compounds form a thin layer on the electrode surface, and this is known as the “solid electrolyte interface” (SEI). This separates the electrode and the electrolyte from one another and thus prevents any further electrolyte decomposition, which makes a significant contribution to the operational safety of the batteries. The drawback of graphite anodes is that they only have approximately 1/10 of the capacity of metal Li, and it is accordingly advantageous to use stable lithium-metal anodes.

The established approach to this is to use a solid-state electrolyte instead of the known liquid electrolyte, because it is much more stable against metal lithium and therefore is safer. These are not completely inert against metal lithium, however, and also form an SEI, and their Li⁺ conductivity is to some extent considerably lower than that of their liquid equivalents. Therefore, solid-state electrolytes have to have high Li⁺ conductivity, in order to ensure the functionality of the battery, and also form an advantageous SEI at the same time. This has to be chemically, electrochemically and mechanically stable, in order to withstand both the reactivity of the lithium metal and the volume changes to the anode. Otherwise, the problems described in the first section occur.

Despite decades of research, solid-state electrolytes at most fulfil one of these requirements, but not both, which is why solid-state batteries are rarely used commercially. The only noteworthy exception is vitreous lithium phosphorus oxynitride (LiPON), which forms an extremely stable, self-healing SEI that has high Li⁺ conductivity and is made of Li₃N, Li₃P und Li₂O, which allows lithium-metal anodes to be used. Owing to its low Li⁺ conductivity of 10⁻⁶ Scm⁻¹, however, LiPON can only be used in thin-film batteries, and not on an industrial scale, since LiPON is produced in a sputtering process that requires a high vacuum.

The LiPON known in the literature is a material from the class of glasses. Glasses are amorphous, non-metal, inorganic materials in which the individual atoms are bonded to one another by covalent and/or ionic bonds (according to the literature, these include Li₂O, P₂O₅ and PON (Dudney, N. J. (2000), Addition of a thin-film inorganic solid electrolyte (LiPON) as a protective film in lithium batteries with a liquid electrolyte, Journal of Power Sources, 89(2), 176-179)). Conventionally, glasses are produced in a melting process. In this case, the starting materials (e.g. SiO₂ and metal oxides (CaO, Na₂O, MgO, etc.) as additives) are mixed, melted, and shaped while molten. Thin layers having a vitreous structure can be produced by means of vapor deposition processes (e.g. sputtering).

LiPON is typically deposited on surfaces by sputtering Li₃PO₄ in a nitrogen atmosphere (Schwöbel, A., Hausbrand, R., & Jaggermann, W. Interface reactions between LiPON and lithium studied by in-situ X-ray photoemission, Solid State Ionics (2015) 273, 51-54). In this case, the starting material is ceramic (crystalline) Li₃PO₄ in monolithic form, which acts as the target. By being bombarded with ions, fragments are removed from the target. These react with nitrogen and are deposited on a selected carrier medium (substrate). The stoichiometry is controlled by process parameters (such as sputtering rate and nitrogen pressure). This process requires a high vacuum, which is therefore very complex and limits the scale on which it can be used. In addition, a LiPON layer cannot be produced in a self-supporting manner, but can only be deposited on a substrate.

Therefore, until now no solid-state electrolyte has been disclosed with which lithium-metal anodes can be used in larger battery systems. The problem addressed by the present invention is to produce a solid-state electrolyte that has high Li⁺ conductivity and has good processability as well as a stable SEO in contact with lithium-metal anodes. At the same time, the solid-state electrolyte is intended to be able to be produced in ways other than PVD or CVD processes, in particular sputtering, which, in conventional solid-state electrolytes, requires a large amount of equipment and is associated with considerable drawbacks in terms of cost.

This problem is solved with regard to a wet-chemically prepared polymeric lithium phosphorus oxynitride (LiPON) according to claim 1. Claim 4 specifies a method for the production thereof. Claim 12 describes intended purposes of the LiPON according to the invention, while claim 13 describes a battery which comprises a solid-state electrolyte made of the LiPON according to the invention. Claim 17 specifies a method for producing the battery according to the invention. The respective dependent claims represent advantageous developments here.

The present invention thus relates to a wet-chemically prepared polymeric lithium phosphorus oxynitride (LiPON), containing a repeating unit of the general formula I

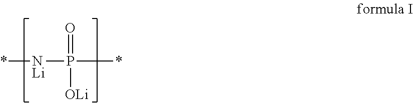

wherein the LiPON is soluble in solvents selected from the group consisting of dimethyl sulfoxide (DMSO), tetrahydrofuran (THF), toluene and N-methylpyrrolidone (NMP).

The LiPON according to the invention differs from the sputtered or crystalline LiPON known up to now in that it has been prepared wet-chemically, i.e. in a solvent. The complex process of sputtering is no longer necessary. The LiPON according to the invention is therefore not a ceramic, but instead is an amorphous, polymeric material, which can dissolve in polar solvents, such as dimethyl sulfoxide, tetrahydrofuran, toluene or N-methylpyrrolidone, unlike the ceramic variants of LiPON, which are sputtered or prepared by means of high-temperature synthesis.

The LiPON according to the invention therefore provides completely new possibilities in terms of use and processing. Therefore, it is for example possible to isolate the LiPON and to handle it as such. It is likewise possible to deposit the LiPON from solutions, for example by film casting or doctoring, etc., for example.

When further processing the LiPON according to the invention, the complex application processes, such as PVD (sputtering) or CVD processes known from the prior art which have to be carried out in a vacuum or in a protective atmosphere with high energy consumption can thus be avoided.

Since the reactivity of the metal lithium cannot be avoided, the electrolyte has to be such that it decomposes into precisely specified products and forms a specific, stable SEI. The SEI of LiPON mentioned at the outset serves as a model. The formation of the lithium salts Li₃N, Li₃P und Li₂O requires the new solid-state electrolyte to have a similar chemical molecular formula to the vitreous LiPON. A suitable material class for this approach is polyphosphazenes, which have a phosphorus-nitrogen main chain. By means of a particular chemical modification, what is known as polymeric LiPON having the molecular formula [Li₂PO₂N]ₙ can be prepared, which is almost identical to the molecular formula of vitreous LiPON. Furthermore, the polyphosphazenes are known solid-state electrolytes, which can reach Li⁺ conductivities of up to 10⁻³ Scm⁻¹, which is comparable to the currently used liquid electrolytes. Therefore, this solid-state electrolyte provides the previously unobtained combination of a stable SEI and high Li⁺ conductivity. In addition, the polymeric LiPON according to the invention is a thermoplastic polymer and thus can melt, meaning that it can also be processed on a large scale by means of known processes such as roll-to-roll processing.

The LiPON according to the invention can in particular be prepared by reacting a polymetaphosphinic acid of the general formula II

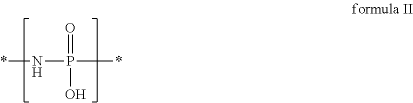

with an organolithium compound.

Preferably, the LiPON according to the invention is characterized by its amorphous nature.

The present invention also relates to a method for preparing polymeric lithium phosphorus oxynitride (LiPON) of the general formula I

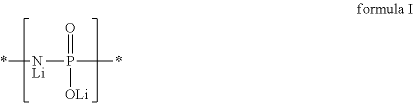

in which a polymetaphosphonic acid of the general formula II

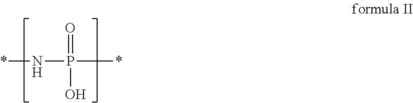

is reacted with an organolithium compound.

The organolithium compound used here is in particular selected from the group consisting of alkyllithium compounds, in particular n-butyllithium, sec-butyllithium, tert-butyllithium, methyllithium, isopropyllithium; aromatic lithium organyls, in particular phenyllithium and mixtures thereof.

Particularly preferably, the reaction is carried out in an inert solvent, preferably in dimethyl sulfoxide (DMSO), a solvent that can be mixed with dimethyl sulfoxide (DMSO), or a mixture of dimethyl sulfoxide (DMSO) and a solvent that can be mixed with dimethyl sulfoxide (DMSO), in particular a solvent selected from the group consisting of toluene, benzene, xylene, dimethyl sulfoxide (DMSO), tetrahydrofuran (THF) and N-methylpyrrolidone (NMP), and mixtures and combinations thereof, in particular in a mixture of dimethyl sulfoxide (DMSO) and toluene.

Preferably, the polymetaphosphinic acid of the general formula II used in DMSO is prepared by reacting poly(dichlorophosphazene) with dimethyl sulfoxide before being reacted with the organolithium compound. The polymetaphosphinic acid is preferably prepared immediately before it is reacted to form the LiPON according to the invention. It is particularly preferred here for the two-stage reaction to be performed in one-pot synthesis. First, the poly(dichlorophosphazene) is reacted with dimethyl sulfoxide to form polymetaphosphinic acid here, and the resulting solution of polymetaphosphinic acid in DMSO is immediately reacted again with the organolithium compound to form the polymeric LiPON according to the invention.

The organolithium compound is used here, based on the lithium equivalents, advantageously 2.0 to 3.0, preferably 2.1 to 2.8, particularly preferably 2.3 to 2.5 equivalents in relation to the nitrogen equivalents of the polymetaphosphinic acid of the general formula II.

The reaction to form LiPON may advantageously be carried out here over a time period of from 10 minutes to 7 days, preferably from 12 hours to 5 days, at a temperature of −20° C. to +60° C., preferably at 0° C. to 40° C., particularly preferably at 10 to 30° C., and/or at a concentration of the polymetaphosphinic acid of the general formula II of from 1 to 200 g/l, preferably 10 to 100 g/l.

Preferably, after the reaction is complete, the polymeric lithium phosphorus oxynitride solidifies, in particular by precipitation, crystallization, extraction and/or removal of the solvent.

If the LiPON according to the invention is precipitated, this is carried out in particular by adding a nitrile-containing solvent, in particular acetonitrile.

The present invention also relates to the use of the LiPON according to the invention as a solid-state electrolyte.

The invention further relates to a battery, which contains the LiPON according to the invention as a solid-state electrolyte.

The battery may for example comprise an anode consisting of lithium or containing lithium, a cathode, and a solid-state electrolyte separating the anode and the cathode and made of the LiPON according to the invention.

Exemplary cathode materials are preferred here which are selected from the group consisting of lithium nickel cobalt manganese (Li(NiCoMn)O₂), lithium manganese oxide spinel (LiMn₂O₄), lithium cobalt oxide (LiCoO₂), lithium iron phosphate (LiFePO₄), lithium nickel cobalt aluminum oxide (LiNiCoAlO₂), lithium manganese phosphate (LMnP), lithium cobalt phosphate (LCoP), lithium nickel phosphate (LNiP), lithium manganese iron phosphate (LMFP), lithium manganese nickel oxide (LMNO), metal fluorides, in particular iron fluoride, copper fluoride, iron copper fluoride; vanadium oxide, metal sulfides, metal silicates, and mixtures and blends thereof.

Possible anode materials are preferred which are selected from the group consisting of metal lithium, lithium titanate oxide (Li₄Ti₅O₁₂), lithium-containing silicon, lithium-containing silicon-carbon composites, lithium alloys, in particular with aluminum, with magnesium, with silicon and/or and with tin, and mixtures and blends thereof.

The present invention also relates to a method for producing a battery according to the invention in which the LiPON according to the invention is used. Here, the solid-state electrolyte made of LiPON is not applied by means of sputtering, as is known from the prior art. In particular, the solid-state electrolyte is prepared only from the LiPON according to the invention, for example by means of doctoring, tape casting and/or pressing.

Owing to the previously unobtained combination of high Li⁺ conductivity, simple processability and the formation of a stable SEI, the solid-state electrolyte set out here is suitable for industrial production of high-energy lithium-ion bulk batteries comprising lithium-metal anodes.

The most significant advantage of the LiPON according to the invention is that the reactivity of the metal lithium is not considered to be a problem to be avoided, but instead is utilized in order to produce targeted decomposition products and therefore a stable protective barrier layer on the lithium-metal anode. This approach has not been previously described in the research.

The present invention will be described in more detail with reference to the following configurations without restricting the invention to the embodiments set out.

For the synthesis of polymeric LiPON, the polymeric polyphosphazene precursor [NPCl₂]ₙ is usually used as a starting point.

There are two options for preparing [NPCl₂]ₙ. First, cyclic N₃P₃Cl₆ can be reacted at temperatures of approx. 250° C. with ring opening to form elongate chains (Allcock, H. R., Crane, C. A., Morrissey, C. T., & Olshavsky, M. A. A New Route to the Phosphazene Polymerization Precursors, Cl₃PNSiMe₃ and (NPCl₂), Inorganic Chemistry (1999), 38(2), 280-283), and second, the cationic polymerization of Cl₃P═NSi(CH₃)₂ (phosphoranimine), as set out in reaction equation 1, can be carried out with PCl₅ as the initiator (Wang, B. Development of a one-pot in situ synthesis of poly(dichlorophosphazene) from PCl₃, Macromolecules (2005), 38(2), 643-645). The latter provides the option of being able to set the molar mass of the polymer on the basis of the initiator/monomer ratio (reaction equation 1; see below).

The synthesis of polymeric LiPON took place in two-stage synthesis (product (2.1) was not isolated, but instead directly processed further). Step (2.1) was based on a concept known in the literature (Walsh, E. J., Kaluzene, S., & Jubach, T. The reactions of halocyclophosphazenes with dimethylsulfoxide. Journal of Inorganic and Nuclear Chemistry (1976) 38(3), 397-399) which did not, however, exist for polymers, and step (2.2) was not previously known.

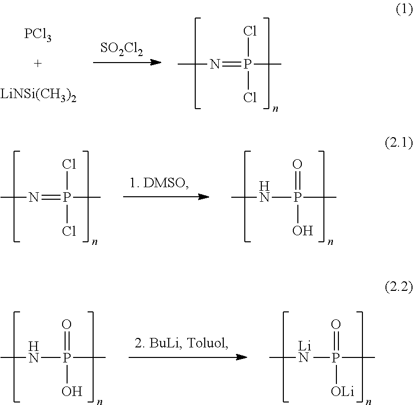

### Synthesis of Polymeric LiPON

### State 1: Synthesis of Poly(dichlorophosphazene)—Reaction Equation (1)

LiN(SiMe₃)₂ (5.17 g, 30.9 mmol) was weighed out with a septum in a heated 250 ml Schlenk flask in the glovebox, was dissolved in 120 ml dried toluene in an argon atmosphere and the solution was cooled to 0° C. PCl₃ (2.7 ml, 30.9 mmol) was then added thereto dropwise over a time period of 10 minutes. The reaction mixture was first stirred for 30 minutes at 0° C. and then for 1 hour at room temperature. The resulting white suspension was cooled to 0° C. again and SO₂Cl₂ (2.55 ml, 31.5 mmol) was then added thereto dropwise over a time period of 10 minutes. The resulting SO₂ was bound in a gas wash bottle filled with sodium hydroxide. The reaction mixture was then stirred for 1 hour at 0° C., PCIs (316 mg, 1.52 mmol) was then added thereto, and was lastly stirred overnight at room temperature.

After approx. 18 hours, the yellow, cloudy solution was filtered over Celite through a fritted glass filter in a heated 250 ml flask and the LiCl was thus removed from the solution. The flask and fritted glass filter were then rinsed twice with a few milliliters of toluene. The solvent was first removed on the rotary evaporator and then in the oil-pump vacuum; this resulted in a viscous, yellow solid.

Yield: 2.9 g (25.2 mmol, 81%)

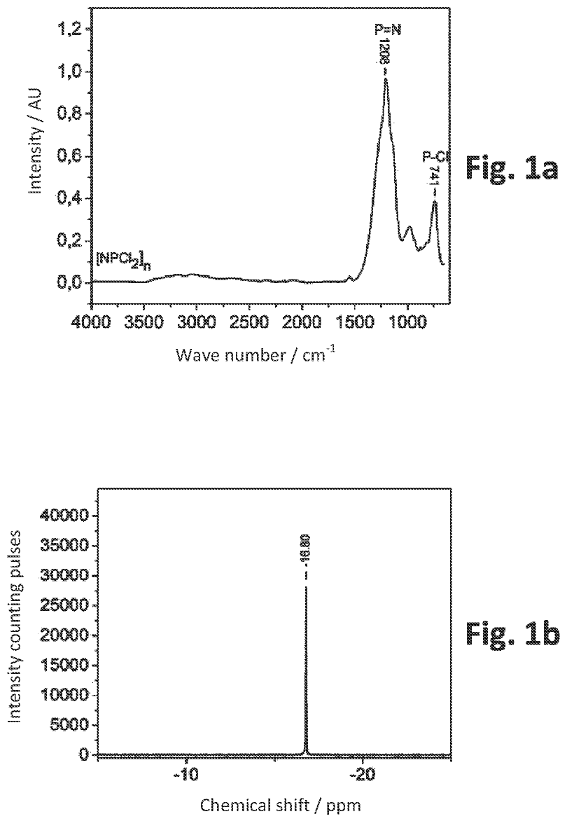

The ³¹P-NMR spectrum of [NPCl₂]ₙ exhibits a signal at −16.8 ppm in CDCl₃, which corresponds to the literature. The same applies to the FTIR spectrum with bands at 1208 cm-1 (P═N vibration) and 741 cm-1 (P—Cl vibration) (see FIGS. 1a and 1b).

### Stage 2: Synthesis of Polymeric LiPON—Reaction Equations (2.1) and (2.2)

Poly(dichlorophosphazene) from stage 1 (1 g, 8.63 mmol) was placed into a 100 ml flask and 15 ml anhydrous DMSO was added thereto while being slowly stirred in a water bath with a little ice. After 2 hours, the water bath was removed and the reaction solution was stirred for 48 hours at 40° C. in an argon atmosphere.

The oil bath was then removed and a resulting, colorless solid was scraped off in the flask above the liquid and was added back into the solution. The suspension was treated in the ultrasound bath for 10 minutes and was then slowly stirred for another 18 hours at room temperature. The by-product was then removed using an upstream cold trap over several hours in the oil-pump vacuum. Once the solution had been topped up again to approx. 15 ml DMSO with 3 ml anhydrous DMSO, it was stirred for another 18 hours. The next day, it was washed 4 times with 15 ml anhydrous diethylether and the residues thereof were removed in the oil-pump vacuum.

Thereafter, the solution was diluted with anhydrous DMSO to a total volume of 30 ml and 7.6 ml of a 2.5 M n-butyllithium/toluene solution (19 mmol, 2.2 eq.) was added thereto dropwise by means of a dropping funnel at the highest stirring speed in a water bath with a little ice. The reaction solution was then stirred for 96 hours at room temperature in an argon atmosphere.

Volatile components were then removed from the solution in the oil-pump vacuum and said solution was washed 3 times with 30 ml diethylether. The remaining diethylether was then removed in the oil-pump vacuum, 60 ml anhydrous acetonitrile was added to the solution and treated in the ultrasound bath for 10 minutes before the product was filtered out by means of a fritted glass filter. The colorless powder obtained was then washed in the fritted glass filter with approx. 6 ml anhydrous acetonitrile and was then dried in the oil-pump vacuum.

Yield: 454 mg (5 mmol, 58%)

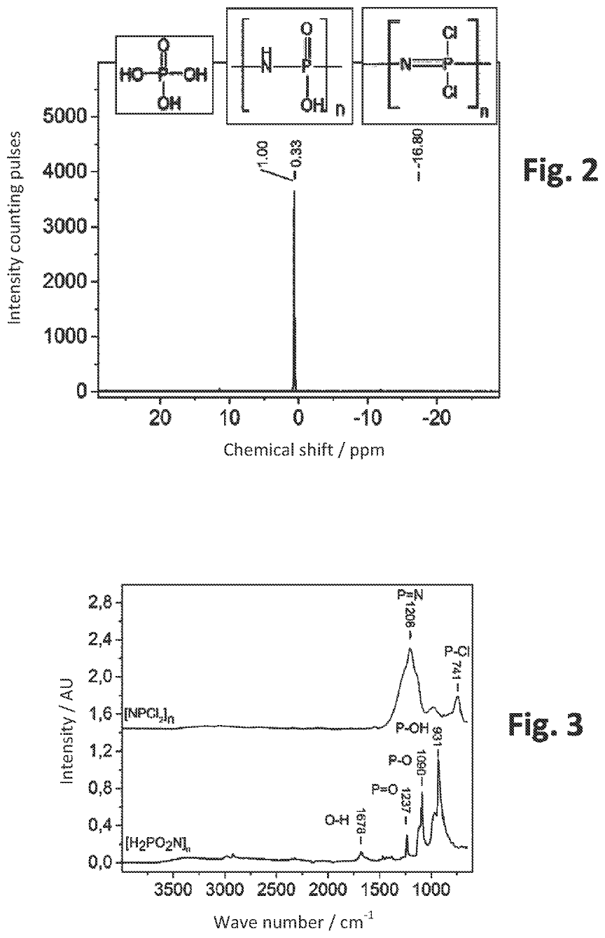

After DMSO was added in the second stage, the starting-material signal in the ³¹P-NMR spectrum disappeared (see FIG. 2) and instead a different signal appeared in DMSO-d6, at approx. +0.3 ppm (see below). Since 85% H₃PO₄ in DMSO-d6 had a shift of +1.0 ppm, the intermediate product had to have a similar to that of phosphoric acid (H₃PO₄).

Since oxygen and nitrogen generate a similar chemical environment due to their similar electronegativity values, the ³¹P-NMR of the intermediate product was indicative of the reaction being correct. The intermediate product could be isolated by the DMSO solution having the [H₂PO₂N]˜ being washed three times with anhydrous diethylether before the butyllithium was added and then being precipitated with anhydrous acetonitrile. The colorless powder obtained had the IR spectrum as shown in FIG. 3.

Since, in this spectrum, the bands of the starting material disappeared and the bands of almost all the functional groups in the expected product appeared at the same time, said product has been produced (also taking into account the ³¹P-NMR spectrum).

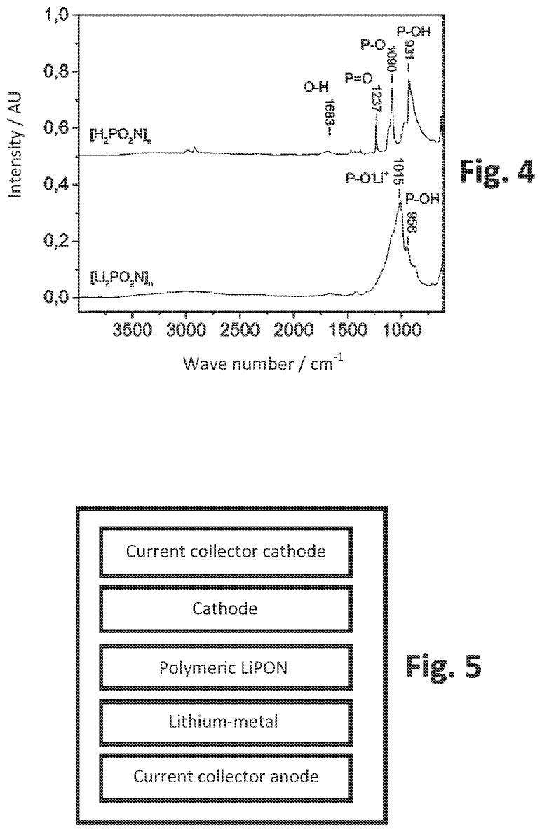

The addition of butyllithium did not result in any change to the ³¹P-NMR spectrum; the signal at approx. 0.3 ppm was still present. Therefore, nothing had changed at the bonds directly to the phosphorus atom. This observation is compatible with reaction equation (2.2), since only the bonding states of the nitrogen and oxygen change here. The FTIR spectrum, however, exhibited significant changes (see FIG. 4).

First, the band for the P—OH bond almost completely disappeared, which was indicative of successful lithiation (O—Li formation, reaction equation 2.2). The band at 1015 cm⁻¹ was assigned to a P—O bond, i.e. a PO—Li⁺ group in the product. The width of this band and the observation that the P—O and P═O bands for the intermediate product were no longer apparent indicated that the negative charge over both oxygen atoms was delocalized (see below on the left), as is known from organic chemistry, e.g. in carboxylates (see below on the right):

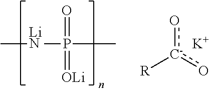

(Right: assumed structure of polymeric LiPON; left: mesomerism in deprotonated carboxylic acids where K⁺=cation).

FIG. 5 shows an exemplary construction of a battery, which can be produced using the polymeric LiPON according to the invention as the solid-state electrolyte. Here, the battery has the construction shown in FIG. 5, with the polymeric LiPON separating the lithium-metal anode and the cathode from one another. The polymeric LiPON can be applied to the cathode material or the anode by means of pressing.

The use of bulk batteries comprising lithium-metal anodes and the solid-state electrolyte described herein is beneficial for any field in which electrical energy accumulators are relevant. This particularly includes vehicle construction, the electrical industry and the building industry.

1. (canceled)

2. (canceled)

3. (canceled)

4. A method for preparing a polymeric lithium phosphorus oxynitride (LiPON) battery, the method comprising:
reacting a polymetaphosphonic acid of the general formula II 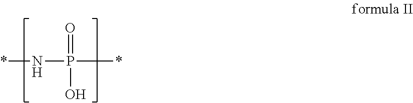
with an organolithium compound to provide a reaction product of the general formula I 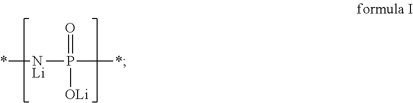
and
including the reaction product in the LiPON battery.

5. The method according to claim 4, wherein the organolithium compound is selected from the group consisting of n-butyllithium, sec-butyllithium, tert-butyllithium, methyllithium, isopropyllithium; phenyllithium and mixtures thereof.

6. The method according to claim 4, wherein the reaction is carried out in dimethyl sulfoxide (DMSO), a solvent that can be mixed with dimethyl sulfoxide (DMSO), or a mixture of dimethyl sulfoxide (DMSO) and a solvent that can be mixed with dimethyl sulfoxide (DMSO), the solvent being selected from the group consisting of a mixture of dimethyl sulfoxide (DMSO) and toluene.

7. The method according to claim 4, wherein the polymetaphosphinic acid of the general formula II has been prepared by reacting poly(dichlorophosphazene) with dimethyl sulfoxide before being reacted with the organolithium compound, the preparation of the polymetaphosphinic acid of the general formula II and the preparation of the LiPON being performed in one-pot synthesis.

8. The method according to claim 4, wherein, based on the lithium equivalents, 2.3 to 2.5 of the organolithium compound are used in relation to the nitrogen equivalents of the polymetaphosphinic acid of the general formula II.

9. The method according to claim 4, wherein the reaction
is carried out over a time period from 12 hours to 5 days,
at a temperature of 10 to 30° C., and/or
at a concentration of the polymetaphosphinic acid of the general formula II of from 10 to 100 g/l.

10. The method according to claim 4, wherein after the reaction is complete, the polymeric lithium phosphorus oxynitride solidifies by precipitation, crystallization and/or removal of the solvent.

11. The method according to claim 10, wherein the precipitation is carried out by adding acetonitrile.

12. Use of a wet-chemically prepared polymeric lithium phosphorus oxynitride (LiPON), containing a repeating unit of the general formula I 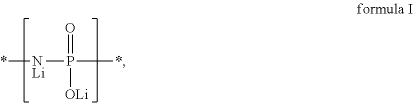
wherein:
the LiPON is soluble in solvents selected from the group consisting of dimethyl sulfoxide (DMSO), tetrahydrofuran (THF), toluene and N-methylpyrrolidone (NMP), and
the LiPON is used as a solid-state electrolyte.

13. A battery comprising a wet-chemically prepared polymeric lithium phosphorus oxynitride (LiPON), containing a repeating unit of the general formula I 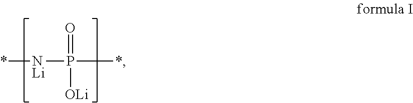
wherein:
the LiPON is soluble in solvents selected from the group consisting of dimethyl sulfoxide (DMSO), tetrahydrofuran (THF), toluene and N-methylpyrrolidone (NMP); and
the LiPON is used as a solid-state electrolyte.

14. The battery according to claim 13, comprising an anode consisting of lithium or containing lithium, a cathode, and a solid-state electrolyte separating the anode and the cathode, the solid-state electrolyte being made of the LiPON.

15. The battery according to claim 14, wherein the cathode is made of or contains a material selected from the group consisting of lithium nickel cobalt manganese (Li(NiCoMn)O2), lithium manganese oxide spinel (LiMn2O4), lithium cobalt oxide (LiCoO2), lithium iron phosphate (LiFePO4), lithium nickel cobalt aluminum oxide (LiNiCoAlO2), lithium manganese phosphate (LMnP), lithium cobalt phosphate (LCoP), lithium nickel phosphate (LNiP), lithium manganese iron phosphate (LMFP), lithium manganese nickel oxide (LMNO), iron fluoride, copper fluoride, iron copper fluoride; vanadium oxide, metal sulfides, metal silicates, and mixtures and blends thereof.

16. The battery according to claim 14, wherein the anode is made of or contains a material selected from the group consisting of metal lithium, lithium titanate oxide (Li4Ti5O12), lithium-containing silicon, lithium-containing silicon-carbon composites, lithium alloys, with aluminum, with magnesium, with silicon and/or and with tin, and mixtures and blends thereof.

17. (canceled)

18. (canceled)

19. The method according to claim 4, wherein the reaction product is amorphous.

20. The method according to claim 4, wherein the solid-state electrolyte is not produced by sputtering.

21. The method according to claim 20, wherein the solid-state electrolyte is prepared by doctoring, tape casting, and/or pressing.

22. The method according to claim 20, wherein the solid-state electrolyte is amorphous.

23. Use of LiPON according to claim 12, wherein the LiPON is prepared by reacting a polymetaphosphinic acid of the general formula II 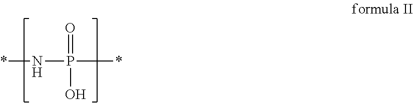
with an organolithium compound.

24. The battery according to claim 13, wherein the LiPON is prepared by reacting a polymetaphosphinic acid of the general formula II 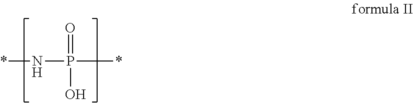
with an organolithium compound.

25. The battery according to claim 13, wherein the LIPON is amorphous.
